(19) United States
(12) Patent Application Publication
(10) Pub. No.: US 2025/0110996 A1
(43) Pub. Date: Apr. 3, 2025

(54) DEEP SEMANTIC SEARCH ENGINES FOR DOCUMENT STORES

(71) Applicant: Dell Products L.P., Round Rock, TX (US)

(72) Inventors: Arunachalam Muthu Valliappan, Austin, TX (US); Tejas Naren Tennur Narayanan, Austin, TX (US)

(21) Appl. No.: 18/480,146

(22) Filed: Oct. 3, 2023

(51) Int. Cl. G06F 16/953; G06F 16/93; G06N 3/045; G06N 3/08

(52) U.S. Cl. CPC G06F 16/953; G06F 16/93; G06N 3/045; G06N 3/08

(57) ABSTRACT

A method facilitating deep semantic search engines for document stores includes generating, by a system including a processor and using a first machine learning model component, semantic representation data for first excerpts of a document. The method also includes producing, by the system, a training dataset based on the document. The training dataset comprises samples, and respective ones of the samples include sample data, selected from the semantic representation data and associated with an excerpt of the first excerpts, and reference data indicative of the document. The method further includes training, by the system and using the training dataset, a second machine learning model component to predict a target document from a group of documents, including the document, having a second excerpt that matches an input query by at least a threshold amount.

### BACKGROUND

Traditional search engines use crawlers that download and index content from various web pages and/or other sources. Due to the high volume of data cataloged by a traditional search engine, a large-scale distributed computing infrastructure is often necessary to yield fast results. While keyword based methods can improve the speed and reduce the computational requirements of a search engine, additional features such as providing high quality semantic matches and retrieval from a large database conventionally require significantly higher computational resources.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include a memory that stores executable components and a processor that executes the executable components stored in the memory. The executable components can include a text encoding component that generates, using a first machine learning model layer, semantic representations of first text present in respective defined portions of a document. The executable components can further include a dataset creation component that generates a group of training data samples corresponding to the document, where respective ones of the training data samples include a semantic representation, of the semantic representations and associated with a defined portion of the respective defined portions of the document, and a reference to the document. The executable components can also include a model training component that trains, using the group of training data samples, a second machine learning model layer to determine a predicted document from a group of documents, including the document, having second text that exhibits at least a threshold degree of similarity to an input query as determined with reference to a defined similarity function.

In another implementation, a method is described herein. The method can include generating, by a system including a processor and using a first machine learning model component, semantic representation data for first excerpts of a document. The method can additionally include producing, by the system, a training dataset based on the document, where the training dataset includes samples, respective ones of the samples including sample data, selected from the semantic representation data and associated with an excerpt of the first excerpts, and reference data indicative of the document. The method can further include training, by the system and using the training dataset, a second machine learning model component to predict a target document from a group of documents, including the document, having a second excerpt that matches an input query by at least a threshold amount.

In an additional implementation, a non-transitory machine-readable medium is described herein that can include instructions that, when executed by a processor, facilitate performance of operations. The operations can include generating semantic data based on first text located in respective sections of a document; constructing a training dataset corresponding to the document, the training dataset including samples, where respective ones of the samples include a portion of the semantic data associated with a section of the sections of the document and reference data indicative of an identity of the document; and training, using the training dataset, a machine learning model to determine a predicted document from a group of documents, including the document, that includes second text that is determined to be similar to a query by at least a threshold degree.

### DESCRIPTION OF DRAWINGS

Various non-limiting embodiments of the subject disclosure are described with reference to the following figures, wherein like reference numerals refer to like parts throughout unless otherwise specified.

FIGS. 1-2 are block diagrams of respective systems that facilitate deep semantic search engines for document stores in accordance with various implementations described herein.

FIG. 3 is a diagram depicting an example model architecture that can be utilized by various implementations described herein.

FIG. 4 is a block diagram of another system that facilitates deep semantic search engines for document stores in accordance with various implementations described herein.

FIGS. 5-6 are diagrams depicting a non-limiting example implementation of a deep semantic search engine for knowledge base articles.

FIGS. 7-8 are block diagrams of respective additional systems that facilitate deep semantic search engines for document stores in accordance with various implementations described herein.

FIG. 9 is a flow diagram of a method that facilitates deep semantic search engines for document stores in accordance with various implementations described herein.

FIG. 10 is a flow diagram depicting respective operations facilitating deep semantic search engines for document stores that can performed by a processor in accordance with various implementations described herein.

FIGS. 11-12 are diagrams of respective example computing environments in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

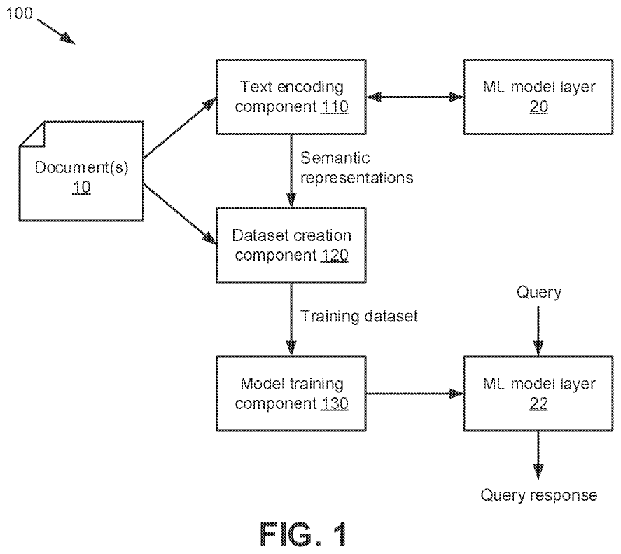

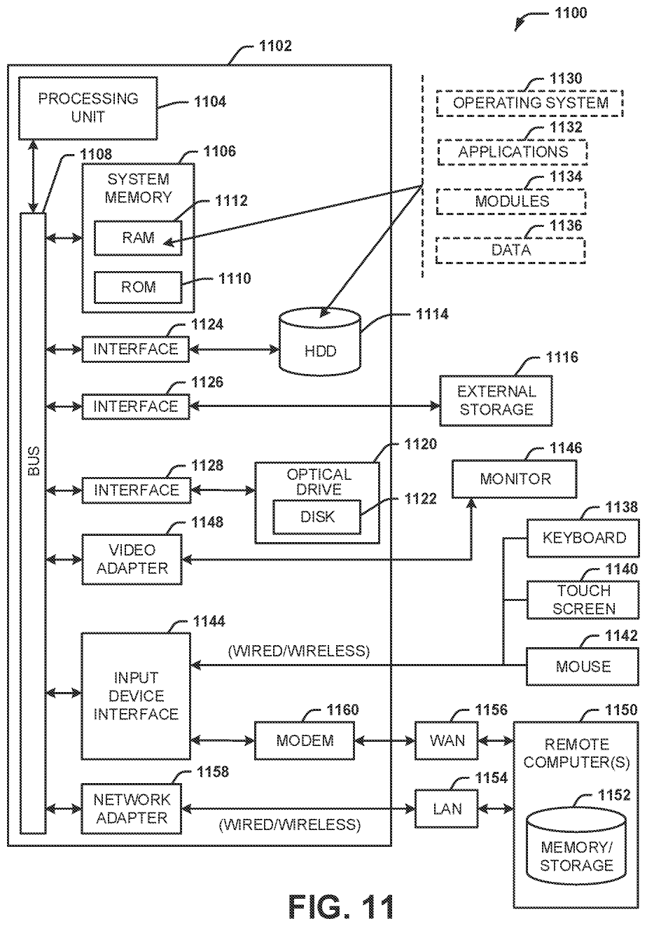

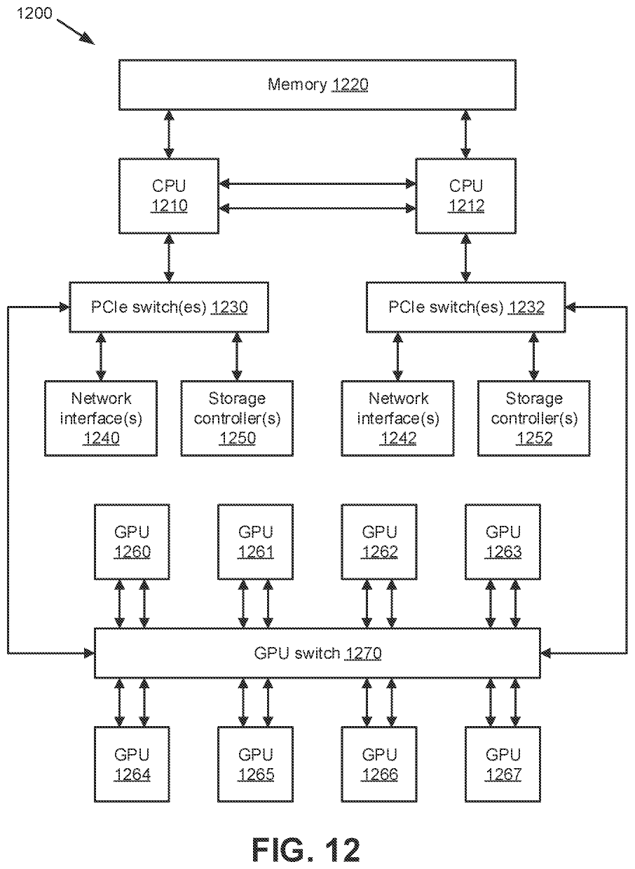

With reference now to the drawings, FIG. 1 illustrates a block diagram of a system 100 that facilitates deep semantic search engines for document stores in accordance with various implementations described herein. System 100 as shown in FIG. 1 includes a text encoding component 110, a dataset creation component 120, and a model training component 130, each of which can operate as described in further detail below. In an implementation, the components 110, 120, 130 of system 100 can be implemented in hardware, software, or a combination of hardware and software. By way of example, the components 110, 120, 130 can be implemented as computer-executable components, e.g., components stored on a memory and executed by a processor. Examples of computer architectures including a processor and a memory that can be used to implement the components 110, 120, 130 as well as other components as will be described herein, are shown and described in further detail below with respect to FIGS. 11-12.

Additionally, it is noted that the functionality of the respective components shown and described herein can be implemented via a single computing device and/or a combination of devices. For instance, in various implementations, the text encoding component 110 shown in FIG. 1 could be implemented via a first device, the dataset creation component 120 could be implemented via the first device or a second device, and the model training component 130 could be implemented via the first device, the second device, or a third device. Also, or alternatively, the functionality of a single component could be divided among multiple devices in some implementations.

Machine learning (ML) models, such as deep learning models or the like, can be used in connection with search engines and/or other similar implementations to enhance the accuracy and relevance of results presented in response to a query. By way of specific, non-limiting example, a ML-driven search engine associated with a knowledge base can give answer such as a cause of a problem, symptoms indicating a problem, and/or solutions one can take to resolve a problem, based on the meaning of a query a user provides to describe the problem. However, existing ML models for problem identification, including intent identification, can require large amounts of labeled data, which can be costly to obtain and quickly outdated with time. Additionally, these existing models can in some cases provide low-quality results, e.g., due to an inability to understand the context of a query. Existing models also often scale poorly with increasing size of an underlying database, which is undesirable for an implementation such as a knowledge base where the model is updated frequently with new information.

In view of at least the above, various implementations described herein utilize classification models to provide high-accuracy semantic matching and near-instant retrieval from a document store such as a knowledge base. Techniques described herein can leverage all of the information present in a document store in an instantaneous manner without the need for large amounts of manual work associated with labeling data, designing process flows, etc., associated with conventional techniques such as keyword-based approaches. Additionally, implementations described herein can provide users with a single-click solution, e.g., without detailed flows involving multiple questions and answers and/or the wait times associated with connecting to a human agent.

In general, various implementations as described herein can process information present in a document store, efficiently retrieve a target source of information, and provide information from the target source when a related question is asked. The implementations described herein can be used in applications that include, but are not limited to, question answering (QA) chatbots, next best action (NBA) systems that assist agents, search tools for document archives, semantic search for areas of a document, and/or any other application in which documents with any degree of relevancy to a given query are desirably identified and/or classified.

The above and/or other implementations as described herein can provide various advantages that can improve the performance of a computing system. For instance, a classification model trained and/or tuned using a training dataset that is generated and structured as described herein can provide relevant results faster and with less resource consumption (e.g., in terms of processor cycles, network bandwidth, operating costs, power consumption, etc.) than conventional techniques. Additionally, various implementations described herein can utilize significantly less memory than conventional approaches, which can enable the use of these implementations on less powerful computing devices, such as laptop computers, that cannot practically perform conventional techniques for achieving similar results due to their requirements. Moreover, implementations described herein can provide responses to user queries with improved accuracy, which can reduce the number of follow-up queries provided to the system and their associated computational cost. Other advantages of the implementations described herein are also possible.

It is noted that while some implementations are described herein with reference to specific types of ML models, other types of models could be utilized to attain similar results, as will be described in further detail below. It is also noted that, due to the nature and quantity of data that can be processed by ML models as described herein, as well as the manner in which such data is processed, implementations described herein can facilitate operations that could not be performed in the human mind, or by a general-purpose computer utilizing conventional computing techniques, in a useful or reasonable timeframe. Additionally, while some implementations herein are described with reference to a knowledge base composed of articles that describe technical problems (e.g., malfunctions) that can occur in a computing device or system, it is noted that a knowledge base is merely one example of a document store that can be processed using the techniques described herein and that other types of document stores could also be used without departing from the scope of this description or the claimed subject matter.

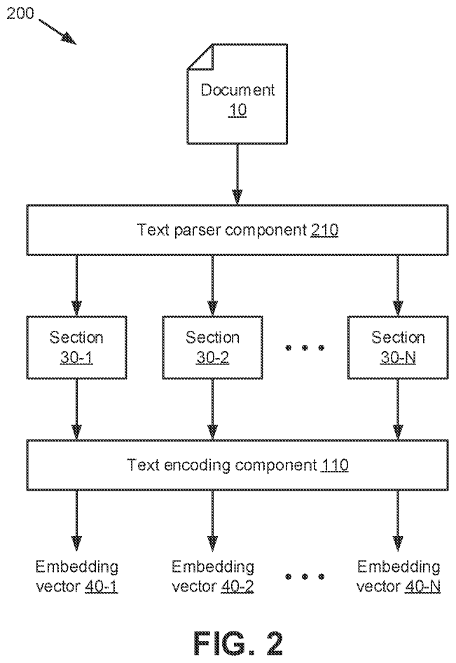

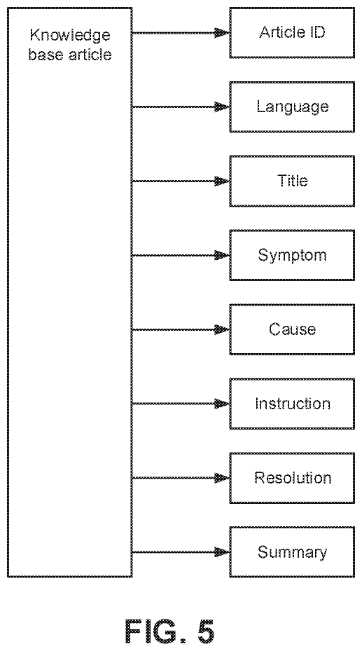

With reference now to the components of system 100, the text encoding component 110 can process one or more documents 10 to generate, using a first ML layer 20, semantic representations of text present in respective defined portions of the document(s) 10. As used in this context, a “semantic representation,” or “semantic representation data,” refers to any data derived from a body of text that can be used to represent semantic concepts and/or context associated with that text. Additionally, respective portions of a document as processed by the text encoding component 110 can include any suitable divisions of a document, e.g., chapters, sections, excerpts, or other portions, that can include some or all of the document. An example in which numeric embedding vectors are used as semantic representation data for defined sections of a document is described in further detail below with respect to FIG. 2. Additionally, example subdivisions of a document that can be utilized by the text encoding component 110 are described in further detail below with respect to FIG. 5.

The dataset creation component 120 of system 100 can generate a training dataset, e.g., composed of a group of training data samples, for respective document(s) 10 based on the semantic representation data provided by the text encoding component 110. In an implementation, a training data sample generated by the dataset creation component 120 for a given document 10 can include the semantic representation generated by the text encoding component 110 for the document 10 as well as a reference to the document 10, e.g., a title of the document, a location of the document in a file or object storage system, an identifier assigned to the document, etc.

The model training component 130 of system 100 can leverage the training dataset generated by the dataset creation component 120 to train a second ML model layer 22. In various implementations, the second ML model layer 22 can be associated with the same ML model as the first ML model layer 20 described above, or alternatively the ML model layers 20, 22 can correspond to different ML models. As further shown by FIG. 1, the model training component 130 can train the second ML model layer 22 to predict a document, e.g., from the documents 10, that contains text (e.g., in a section, excerpt, etc. of the document as processed by the text encoding component 110) that is similar to an input query by at least a threshold degree, e.g., as determined with reference to a similarity function and/or other means. In one implementation, the model training component 130 can train the second ML model layer 22 to identify, in response to a query, one or more of the document(s) 10 that contains text that most closely matches the text of the query. Other functions performed by the second ML model layer 22 could also be facilitated via the training conducted by the model training component 130.

Turning now to FIG. 2, a block diagram of a system 200 that facilitates generation of semantic data for a document 10 is illustrated. Repetitive description of like parts described above with regard to other implementations is omitted for brevity. System 200 includes a text parser component 210 that can divide a document 10 into respective sections 30 based on suitable parsing criteria. By way of a non-limiting example in which the document 10 is a Hypertext Markup Language (HTML) document, the text parser component 210 can divide the document 10 into sections that are defined by HTML tags and/or other markers present in the document 10. Other techniques could also be used. For instance, the text parser component 210 could divide a document 10 into sections 30 based on section headers present in the document (e.g., one or more words in the document that are formatted differently from other text in the document to indicate their status as a header), text content of the document, a defined section size (e.g., such that the sections 30 are of a uniform or near-uniform length), and/or any other suitable criteria.

The text parser component 210 shown in system 200 can additionally process the text present in each of the sections 30 such that the sections 30 are provided in a standardized format to the text encoding component 110. For example, if the text encoding component 110 is configured to process plain text, the text parser component 210 can remove formatting from the respective sections 30 of the document 10 to facilitate successful encoding.

In various implementations, a document 10 can be manually provided to the text parser component 210 for processing as shown in FIG. 2. Also or alternatively, documents 10 can be automatically provided to the text parser component 210, e.g., by using a text scraper or a similar application to capture the documents 10 as they are stored and/or published.

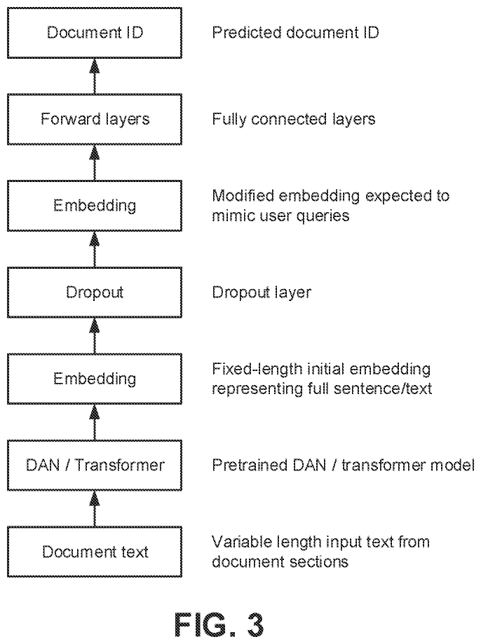

As further shown in FIG. 2, the text encoding component 110 can process each of the sections 30 generated by the text parser component to generate semantic representation data, here in the form of embedding vectors 40 corresponding to each of the sections. It is noted that other types of semantic representation data could also be used. The use of embedding vectors as semantic representation data is described in further detail below with respect to FIG. 3. Additionally, while FIG. 2 illustrates processing for a single document 10, it is noted that the text parser component 210 and text encoding component 110 could process multiple documents 10 in a similar manner to that shown by FIG. 2.

System 200 as shown in FIG. 2 can be utilized to process new documents in a document store, e.g., as they are uploaded to and/or otherwise associated with the document store. In some implementations, processing as shown by system 200 can occur continuously, e.g., to generate training data samples for respective documents as those documents are received. A corresponding ML model can then be trained using the new training data samples, e.g., by a model training component 130 as described above, at respective uniform or non-uniform periods. By way of example, the model training component 130 can batch incoming training data samples and perform model retraining at regular times, e.g., once a week, twice a month, etc. Other training strategies could also be used.

Turning now to FIG. 3, an example model architecture that can be utilized by various implementations described herein is illustrated. It is noted that the architecture shown by FIG. 3 is merely an example of an architecture that could be utilized, and that other implementations are also possible that could vary, either partially or completely, from the architecture shown in FIG. 3.

Conventional methods for measuring document similarity and/or performing document retrieval based on proximity of meaning generally utilize methods such as pairwise similarity scoring, using fuzzy matches or Siamese networks where each existing entry is evaluated for resemblance to a given query, or by using clustering and/or nearest neighbor models. However, these methods each require any given entry to be compared with every possible candidate query, which consumes a large amount of time. Additionally, many conventional matching techniques have poor time complexity, ranging from fuzzy matches which have exponential time complexity to embedding similarities which become increasingly more expensive with larger text documents. The multiplication of these 2 factors, e.g., evaluating similarity between a document and a query and repeating this evaluation for every document, quickly becomes very expensive. While optimizations are possible, such as by storing the embeddings in advance, these optimizations increase the memory requirement of the model. This can become very expensive as the size of an underlying document store increases, especially in implementations where a high query volume is expected.

In contrast, the architecture shown in FIG. 3 treats every query like a classification problem where for a given input query, a classification model will predict the correct document ID. In an implementation in which document IDs are hashes, this can be implemented via the use of a classification model as a semantic memorization model, where the model is trained to identify which document a given query belongs to. Since this is a memorization/retrieval objective, generalization can be performed, e.g., by using special training methods to ensure that the model does not overfit the document text and can generalize well to any given user query, especially queries that contain typographical mistakes.

The model architecture shown in FIG. 3 can initially receive document text as input, which can include variable-length input text from sections and/or other defined portions of a group of documents, e.g., the document sections 30 shown in FIG. 2. The input text can then be provided to a ML model layer, such as a deep averaging network (DAN), a transformer-based model, or the like, to obtain fixed-length initial embeddings representing the input text. In an implementation, the model layer utilized for this purpose can include a pretrained DAN and/or transformer-based model, which can be used to obtain embeddings in a very short time (e.g., with time complexity O(n) for a DAN or O(n²) for a transformer model).

In the example architecture shown by FIG. 3, the DAN and/or transformer model is a pretrained model, e.g., based on the Google Universal Sentence Encoder (GUSE) and/or other similar pretrained model suites, and no further training is performed on this model using any training data generated as part of the illustrated architecture. Alternatively, this model could be separately trained, e.g., to improve model performance if the text of the document store on which the model is being used differs from generally-accepted standard text (e.g., in terms of formatting, structure, vocabulary, etc.) on which the pretrained model was trained.

The initial embeddings produced by the DAN and/or transformer model can take the form of embedding vectors, which can include respective vector components that represent the meaning of the processed text. The number of vector components present in an embedding vector is also referred to as the number of dimensions of the vector. As further shown in FIG. 3, the initial embedding vectors are additionally processed using a dropout parameter to obtain modified embeddings that are expected to mimic user queries. The dropout parameter can be used to generalize the embeddings, e.g., to avoid overfitting to the exact wording and structure of the underlying documents.

In the dropout step, a relatively high dropout value can be applied to the embeddings, based on which respective vector components of the initial embeddings can be removed and/or replaced with other component values. In an implementation, the dropout value can represent the probability that a given vector component will be altered, which as a result also represents the relative portion of the components of a given vector that will be altered. By way of a non-limiting example in which the dropout parameter is 0.25, 25 percent of the components of a given embedding vector can be removed and replaced with zero or null components, random components, and/or any other components that serve to introduce noise into the embeddings. Replacement of vector components can be done randomly and/or in other manners, such as via an entropy-based system that would remove every fourth vector component for a dropout parameter of 0.25, for example. As a result of applying a dropout to the initial embeddings, modified embeddings are produced that enable improved generalization of curated document text with user queries which might include typos, grammatical errors, different sentence structures, etc.

As further shown by FIG. 3, the modified embeddings are processed via a set of forward layers, e.g., two forward layers where the final layer is the size of the number of documents in the underlying document store. In an implementation, the forward layers can transform the modified embeddings into vectors of probabilities, or confidence values, that the embedded text matches respective ones of the documents in the store. An embedding can then be mapped to a predicted document ID based on a vector component of its corresponding probability vector, e.g., by using the ID of the document corresponding to the component of the probability vector having the highest confidence value and/or selected in any other suitable way.

As a result of the above processing steps, the architecture shown in FIG. 3 can classify a document from a group of stored documents that given input text is from. Because deep learning models can overfit even in the presence of high dropouts, the initial stages of the architecture shown in FIG. 3 can be cut from the backpropagation gradient flow, e.g., such that only the feed forward classification layers after the dropout are trainable in the model.

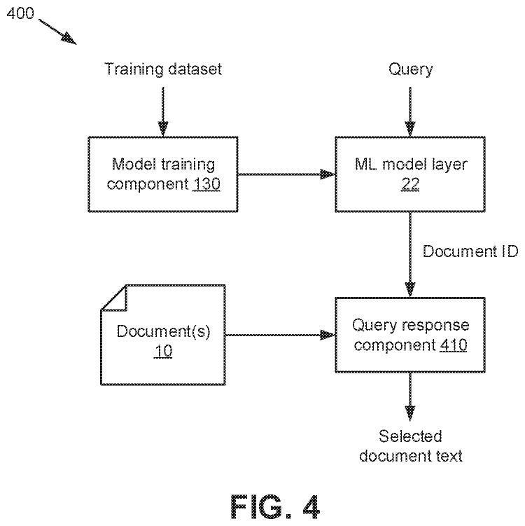

Moving to FIG. 4, a block diagram of another system 400 that facilitates deep semantic search engines for document stores is provided. Repetitive description of like parts described above with regard to other implementations is omitted for brevity. System 400 includes an ML model layer 22 that can predict a document that mimics an input query based on training performed by a model training component 130, e.g., as described above. As shown in FIG. 4, the output of the ML model layer 22 can be an ID of the predicted document and/or another suitable reference to the document.

System 400 as shown in FIG. 4 further includes a query response component 410 that can return, in response to the ML model layer 22 producing a predicted document ID based on an input query, selected text from the predicted document. For instance, in response to the ML model layer 22 determining that the input query mimics a first section of the document, the query response component 410 can return a second, different section of that document, and/or other text from the document that is not part of the first section. By way of example, the input query can correspond to a technical issue or other question addressed in the document, and the output of the query response component 410 can include other text from the document that relates to a resolution of that issue.

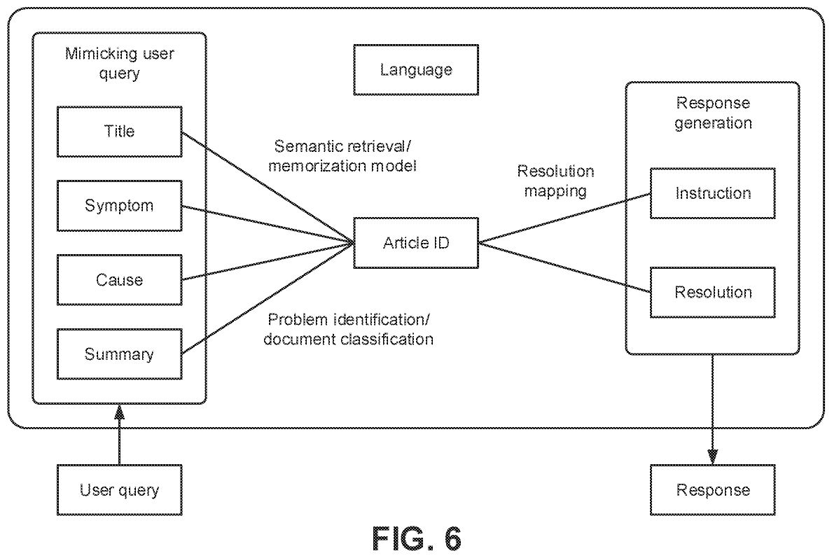

Turning next to FIGS. 5-6, a specific, non-limiting example implementation of system 400 is described in which the document store managed by system 400 is a knowledge base (KB) that includes articles that can contain information on topics ranging from product queries, common problems (technical issues, malfunctions, etc.) in systems and corresponding solutions, guides on troubleshooting and/or upgrading, product specification sheets, and/or other suitable information. It is noted, however, that this implementation is merely one example of a document store that can be processed according to the concepts described herein, and that other types of document stores could be managed in a similar manner without departing from the scope of this description or the claimed subject matter.

Referring now to FIG. 5, a structure of an example KB article is shown with reference to its respective parts. In an implementation, the article parts shown in FIG. 5 can be the sections utilized for dividing the articles into training data samples, e.g., as described above. The sections shown in FIG. 5 for a typical KB article are as follows:

Article ID: A value, e.g., a hashed value, serving as a unique identifier of the article across all languages.

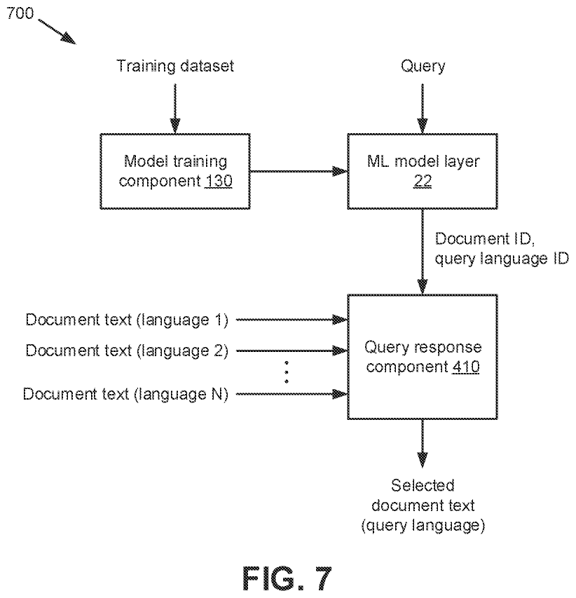

Language: A language ID used to differentiate between different translated versions of the same article in different languages. Techniques for distinguishing between different language versions of a document are described in further detail below with respect to FIG. 7.

Title: A title of the article, e.g., “How to upgrade the RAM in Product X,” “Slow performance in Product Y,” etc.

Symptom: Symptoms indicative of this particular problem, e.g., appearance of a particular error message in a blue screen, unusual noise from a fan, etc.

Cause: Cause of the problem, e.g., liquid spills or damage, outdated firmware version, etc.

Instruction: Instructions to solve the problem, e.g., update the firmware, etc.

Resolution: Resolutions for the problem, e.g., replace the hard drive, etc.

Summary: A summary of the entire article.

Turning to FIG. 6, an example implementation of a classification model is illustrated that can function as part of a chatbot or search engine, e.g., as provided on a website or the like, in which a user query is provided as input and a corresponding response is provided as output. With reference to the KB article parts described in FIG. 5, it is noted that four sections of a KB article, e.g., the Title, Summary, Symptom, and Cause sections, are generally how a user describes a problem. For instance, a user could describe a problem based on an error message they see on their screen (Symptom), a problem due to a cause they know such as accidental damage or problems after a software update (Cause), or a topic on which a user needs further information such as how to upgrade an operating system or replace memory (Summary/Title). As a result, these fields can be used as proxy fields which can capture the context of a user describing a given problem. This combination of fields can therefore be used as input text to train the model, e.g., in order to mimic user descriptions of problems and enable the model to create and understand a holistic picture of the entire problem along with any appropriate context to enable better semantic matches.

The classification model represented in FIG. 6 can be trained on predicting KB article IDs, which here are random hashed IDs. Because the four sections outlined above are expected to contain very different text addressing a different angle of the problem described by a KB article, these sections are not expected to have much similarity between them, and any measurement of validation during training is expected to give an accuracy near zero. Accordingly, the model prediction represented by FIG. 6 can be treated as a semantic memorization problem where there is no validation or test set split from the training data. All of the data present in the KB can be used for training, and special steps, such as the dropout described above with respect to FIG. 3, can be taken to ensure that the model does not overfit the KB text.

As further shown in FIG. 6, the output of the system can be a simple combination of the Resolution and Instruction sections isolated from the KB article. If the KB article ID is identified correctly, the problem will be identified correctly and in turn the corresponding solution can be recommended to the user to resolve the queried issue.

With reference now to FIG. 7, a block diagram of an additional system 700 that facilitates deep semantic search engines for document stores is illustrated. Repetitive description of like parts described above with regard to other implementations is omitted for brevity. System 700 as shown in FIG. 7 includes a model training component 130 that can train an ML model layer 22 using a training dataset that can be generated, e.g., as described above. As described above with respect to FIG. 5, some documents, such as KB articles, can include text in multiple languages that correspond to the same document. As such, the model training component 130 can train the ML model layer 22 to predict a document ID corresponding to a query as well as to identify a language in which the query was written.

As shown in FIG. 7, the output of the ML model layer 22 for a given query can include the predicted document ID corresponding to that query as well as an indication of a language associated with the query, such as a language ID or the like. Based on this information, the query response component 410 of system 700 can formulate a text response to the query in the same language in which the query was written, e.g., by providing selections of text from the predicted document in the specified language. To this end, the query response component 410, as well as components utilized in training the ML model layer 22 as described above, can access document text in multiple languages in which those documents are written. In some implementations, each document may contain separate sections for different languages, e.g., such that a single document contains text in multiple languages. Alternatively, multiple different language versions of the same document could be provided, e.g., that each have the same document ID. The query response component 410 can then use this multilingual text to provide an output to the query in the appropriate language.

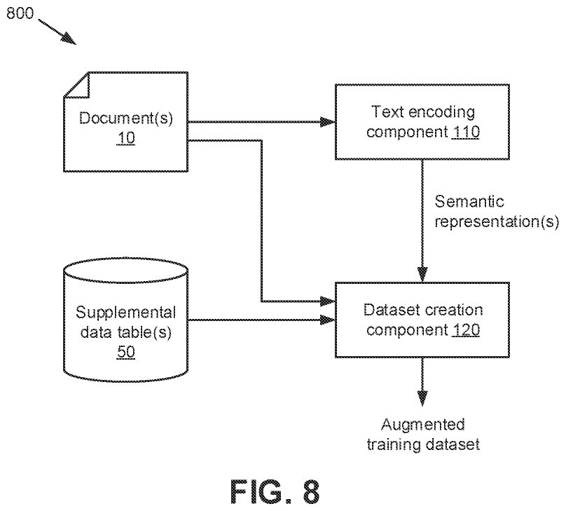

Referring next to FIG. 8, a block diagram of still another system 800 that facilitates deep semantic search engines for document stores is illustrated. Repetitive description of like parts described above with regard to other implementations is omitted for brevity. System 800 as shown in FIG. 8 includes a text encoding component that can provide semantic representation data to a dataset creation component 120 based on respective documents 10 of a document store, e.g., as described above with respect to FIG. 1. As further shown in FIG. 8, the dataset creation component 120 can augment the semantic representation data with supplemental data from one or more other sources, such as supplemental data tables 50 or the like. In an implementation, the supplemental data provided to the dataset creation component 120 can be used to generate additional training data samples for training an ML model (not shown in FIG. 8) to answer additional class(es) of queries, e.g., that are associated with topics that are not addressed by the documents 10, with minimal addition of new training data.

By way of a non-limiting example, the documents 10 shown in FIG. 8 can be associated with a KB that addresses technical issues or the like, and the supplemental data table(s) 50 can include a configurable business rules table that can enable an ML model, through training data constructed by the dataset creation component 120, to identify the meaning of additional classes of questions, such as purchase-related questions, warranty-related questions, or the like, and provide pre-configured answers. In this manner, a chatbot or other application, operating according to a single set of training data, can be given the ability to answer additional types of questions.

In another non-limiting example, the supplemental data table(s) 50 can include telemetry data and/or other data that supplements the text present in the documents 10. For instance, in the implementation where the documents 10 correspond to a KB, a supplemental data table 50 can include telemetry data indicative of actions live agents have previously taken in response to being presented with technical issues that are similar to those described in the KB, and this telemetry data can be used to further tune the associated ML model.

In an implementation, an ML model trained according to a dataset created as shown by FIG. 8 can be configured to answer different classes of queries differently based on the provided training data. For instance, queries relating to topics covered by the documents 10 can be answered using text present in a selected one of the documents 10, while other queries relating to topics covered in the supplemental data table(s) 50 can be given pre-configured responses, e.g., that are specified by the supplemental data.

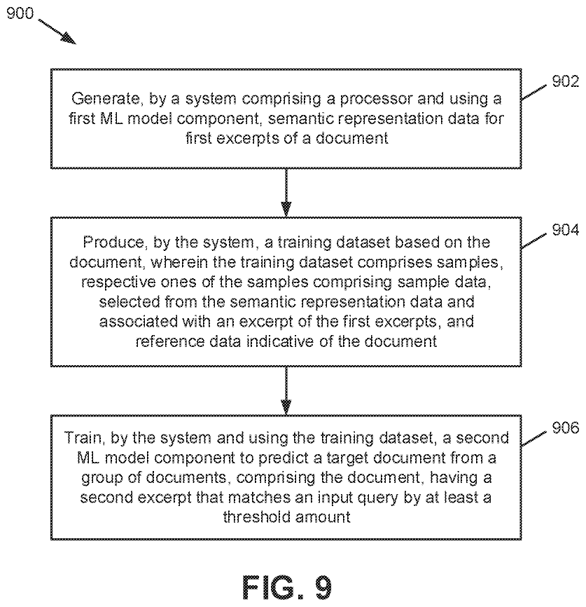

Turning to FIG. 9, a flow diagram of a method 900 that facilitates time series anomaly detection with rare event failure prediction is illustrated. At 902, a system comprising a processor can generate (e.g., by a text encoding component 110), using a first ML model component (e.g., an ML model layer 20), semantic representation data for first excerpts of a document (e.g., a document 10).

At 904, the system can produce (e.g., by a dataset creation component 120) a training dataset based on the document. Here, the training dataset can comprise samples, and respective ones of the samples can include sample data, selected from the semantic representation data generated at 902 and associated with an excerpt of the first excerpts processed at 902, and reference data indicative of the document with which the sample is associated.

At 906, the system can train (e.g., by a model training component 130), using the dataset generated at 904, a second ML model component (e.g., an ML model layer 22) to predict a target document from a group of documents, including the document processed at 902, having a second excerpt that matches an input query by at least a threshold amount.

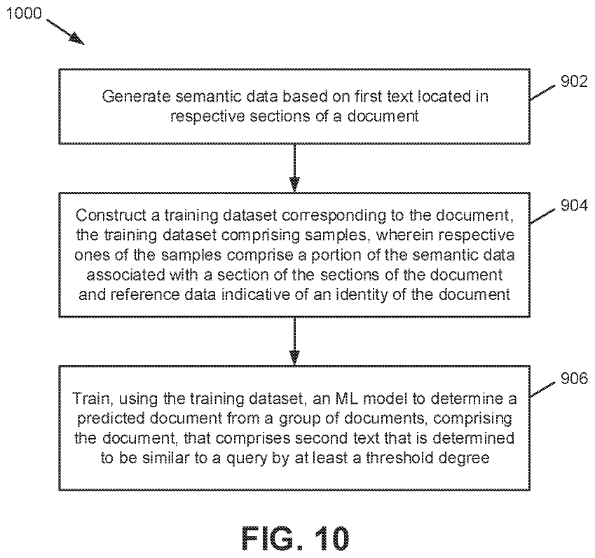

Referring next to FIG. 10, a flow diagram of a method 1000 that can be performed by a processor, e.g., based on machine-executable instructions stored on a non-transitory machine-readable medium, is illustrated. Example of computer architectures, including a processor and non-transitory media, that can be utilized to implement method 1000 are described below with respect to FIGS. 11-12.

Method 1000 can begin at 1002, in which the processor can generate semantic data based on first text located in respective sections of a document.

At 1004, the processor can construct a training dataset corresponding to the document. The training dataset can comprise samples, and respective ones of the samples can comprise a portion of the semantic data associated with a section of the sections of the document and reference data indicative of an identity of the document.

At 1006, the processor can train, using the training dataset, an ML model to determine a predicted document from a group of documents, comprising the document, that includes second text that is determined to be similar to a query by at least a threshold degree.

FIGS. 9-10 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIGS. 11-12 and the following discussion are intended to provide a brief, general description of suitable computing environments 1100, 1200 in which the various embodiments of the embodiment described herein can be implemented. More particularly, FIG. 11 illustrates a general-purpose computing environment 1100 that can be utilized to implement some of the computer-executable components described above, while FIG. 12 illustrates a server computing environment 1200 on which deep learning models and/or other ML models as described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 11, an example general-purpose environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD), a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Turning next to FIG. 12, an example server architecture 1200 that can be utilized in connection with one or more implementations described above is illustrated. The server architecture 1200 shown in FIG. 12 can be associated with a server device, such as a rackmount server, a blade server, or the like, which can be physically and/or communicatively coupled to a chassis (not shown in FIG. 12) and/or other physical devices for use in a computing environment such as a computing cloud, a data center, etc.

The server architecture 1200 shown in FIG. 12, referred to below as simply a server for brevity, can include one or more central processing units (CPUs), here two CPUs 1210, 1212. In a typical implementation of the server 1200, the CPUs 1210, 1212 are high-performance server processors that provide scalability and a high number of processing cores per CPU, e.g., up to 56 cores per processor for current implementations. The CPUs 1210, 1212 of the server 1200 are communicatively coupled to each other by, e.g., processor interconnect links, such as QuickPath Interconnect (QPI) or Ultra Path Interconnect (UPI) links developed by the Intel® Corporation. Alternatively, other means for coupling the CPUs 1210, 1212, such as a front side bus (FSB) or the like, could also be used. While two interconnect links are shown in FIG. 12 coupling CPUs 1210 and 1212, it is noted that more, or fewer, links could also be used.

The CPUs 1210, 1212 shown in FIG. 12 are additionally coupled to a system memory 1220, which can include one or more Dual In-line Memory Modules (DIMMs) and/or other devices. While the system memory 1220 is illustrated as a single block in FIG. 12 for simplicity, it is noted that the system memory 1220 is typically implemented via a group of memory modules. For example, the CPUs 1210, 1212 can collectively be associated with a number of DIMM slots (e.g., 16 slots, 32 slots, etc.), and DIMMs making up the system memory 1220 can be placed into these slots to facilitate connection to the CPUs 1210, 1212. Depending on implementation, the memory modules making up the system memory 1220 can be communicatively coupled to one, or more, of the CPUs 1210, 1212.

As further shown in FIG. 12, Peripheral Component Interconnect Express (PCIe) switches 1230, 1232 can connect the CPUs 1210, 1212 to respective other components of the server 1200, such as network interfaces 1240, 1242, storage controllers 1250, 1252, or the like. The network interfaces 1240, 1242 can include network interface cards (NICs) and/or other suitable components to facilitate connecting the server 1200 to other servers or suitable computing devices, e.g., in a clustered computing environment. The storage controllers 1250, 1252 can include nonvolatile memory express (NVMe) controllers and/or other interface devices that facilitate the coupling of storage devices, such as non-volatile RAM (NVRAM) devices, SSDs, or the like, to the server 1200.

While FIG. 12 shows a configuration in which each CPU 1210, 1212 is connected to one PCIe switch 1230, 1232, other configurations could be used. For instance, a one-to-many or many-to-one connection scheme could be used between the CPUs 1210, 1212 and the PCIe switches 1230, 1232. Similarly, the network interfaces 1240, 1242 and storage controllers 1250, 1252 could be connected to the PCIe switches 1230, 1232 in a one-to-many or many-to-one configuration in addition to, or in place of, the one-to-one connection scheme shown in FIG. 12.

The server 1200 shown in FIG. 12 further includes a group of co-processors, such as graphics processing units (GPUs), intelligence processing units (IPUs) for artificial intelligence workloads or the like. In FIG. 12, there are eight GPUs 1260-1267, which provide further processing capability to server 1200. While eight GPUs 1260-1267 are shown in FIG. 12, more, or fewer, GPUs could also be used. The GPUs 1260-1267 of server 1200 are preferably specialized GPUs that are designed for high-performance computing applications, such as H100 and/or A100 GPUs developed by the NVIDIA® Corporation, although other GPUs, IPUs, etc., could also be used. Each of the GPUs 1260-1267 of the server are communicatively coupled to each other via suitable communications links, such as NVLink® interconnects developed by the NVIDIA® Corporation and/or other suitable connections. In the example shown by FIG. 12, a GPU 1270 facilitates full interconnection between the GPUs 1260-1267. In other implementations, the GPUs 1260-1267 could instead be interconnected directly without the use of a switch or other means.

As additionally shown by FIG. 12, the GPU 1270 is communicatively coupled to the PCIe switches 1230, 1232 to enable communication between the GPUs 1260-1267 and other components of the server 1200. Other connection schemes could also be used. For instance, one or more of the GPUs 1260-1267 could connect to the PCIe switches 1230, 1232 and/or the CPUs 1210, 1212 directly, e.g., in an implementation in which a GPU 1270 is not present. In this architecture, deep learning models would be executed in the GPUs 1260-1267 rather than the CPUs 1210, 1212.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a memory that stores executable components; and
a processor that executes the executable components stored in the memory, wherein the executable components comprise:
a text encoding component that generates, using a first machine learning model layer, semantic representations of first text present in respective defined portions of a document;
a dataset creation component that generates a group of training data samples corresponding to the document, wherein respective ones of the training data samples comprise a semantic representation, of the semantic representations and associated with a defined portion of the respective defined portions of the document, and a reference to the document; and
a model training component that trains, using the group of training data samples, a second machine learning model layer to determine a predicted document from a group of documents, comprising the document, having second text that exhibits at least a threshold degree of similarity to an input query as determined with reference to a defined similarity function.

2. The system of claim 1, wherein the semantic representations of the first text comprise embedding vectors generated from the first text by the first machine learning model layer.

3. The system of claim 2, wherein the dataset creation component modifies the semantic representations by removing respective components of the embedding vectors according to a dropout parameter prior to generating the group of training data samples.

4. The system of claim 1, wherein the first machine learning model layer is not trained using any of the group of training data samples.

5. The system of claim 1, wherein the group of training data samples is a first group of training data samples related to a first class of input queries, wherein the dataset creation component further generates a second group of training data samples relating to a second class of input queries that is not the first class, and wherein the model training component trains the second machine learning model layer using the first group of training data samples and the second group of training data samples.

6. The system of claim 1, wherein the defined portions of the document are first defined portions, and wherein the executable components further comprise:
a query response component that returns, in response to the input query being provided to the second machine learning model layer and further in response to the second machine learning model layer determining that the document has the second text, a second defined portion of the document that is not any of the first defined portions.

7. The system of claim 6, wherein the document is an article describing a technical issue, and wherein the first defined portions of the document comprise at least one portion selected from a group of portions comprising a title of the article, a summary of the article, a first description of a symptom of the technical issue, and a second description of a cause of the technical issue.

8. The system of claim 7, wherein the second defined portion of the document comprises content of a type selected from a group of types comprising information pertaining to a resolution of the technical issue and instructions to resolve the technical issue.

9. The system of claim 1, wherein the first text is in a first language, and wherein the semantic representations comprise first semantic representations of the first text and second semantic representations of third text, in a second language that is not the first language, present in the respective defined portions of the document.

10. The system of claim 9, wherein the input query is a first input query, and wherein the executable components further comprise:
a query response component that returns, in response to a second input query being provided to the second machine learning model layer in an input language selected from a group comprising the first language and the second language, a text response in a same language as the input language.

11. A method, comprising:
generating, by a system comprising a processor and using a first machine learning model component, semantic representation data for first excerpts of a document;
producing, by the system, a training dataset based on the document, wherein the training dataset comprises samples, respective ones of the samples comprising sample data, selected from the semantic representation data and associated with an excerpt of the first excerpts, and reference data indicative of the document; and
training, by the system and using the training dataset, a second machine learning model component to predict a target document from a group of documents, comprising the document, having a second excerpt that matches an input query by at least a threshold amount.

12. The method of claim 11, wherein the semantic representation data comprises embedding vectors derived from the first excerpts by the first machine learning model component.

13. The method of claim 12, wherein the generating of the semantic representation data comprises removing a portion of vector components from the embedding vectors, wherein a size of the portion of the vector components is defined based on a dropout parameter.

14. The method of claim 11, wherein the first machine learning model component is not trained using the training dataset.

15. The method of claim 11, further comprising:
returning, by the system in response to the input query being provided to the second machine learning model component and further in response to the second machine learning model component determining that the document is the target document, a third excerpt of the document that is not any of the first excerpts.

16. The method of claim 15, wherein:
the document describes a computing system malfunction,
the first excerpts comprise at least one first excerpt of a first type selected from a first group of types comprising a title of the document, a summary of the document, a first description of a symptom of the computing system malfunction, and a second description of a cause of the computing system malfunction, and
the third excerpt is of a second type selected from a second group of types comprising a third description of a resolution of the computing system malfunction and instructions to resolve the computing system malfunction.

17. A non-transitory machine-readable medium comprising computer executable instructions that, when executed by a processor, facilitate performance of operations, the operations comprising:
generating semantic data based on first text located in respective sections of a document;
constructing a training dataset corresponding to the document, the training dataset comprising samples, wherein respective ones of the samples comprise a portion of the semantic data associated with a section of the sections of the document and reference data indicative of an identity of the document; and
training, using the training dataset, a machine learning model to determine a predicted document from a group of documents, comprising the document, that comprises second text that is determined to be similar to a query by at least a threshold degree.

18. The non-transitory machine-readable medium of claim 17, wherein the machine learning model is a first machine learning model, and wherein the semantic data comprises embedding vectors derived from the first text by a second machine learning model.

19. The non-transitory machine-readable medium of claim 18, wherein the generating of the semantic data comprises replacing components of the embedding vectors with null components, the components of the embedding vectors being defined by a dropout parameter.

20. The non-transitory machine-readable medium of claim 17, wherein the operations further comprise:
returning, in response to the query being provided to the machine learning model and further in response to the machine learning model determining that the document comprises the second text, third text from the document that is not the second text.
